(19) United States
(12) Patent Application Publication
(10) Pub. No.: US 2014/0012915 A1
(43) Pub. Date: Jan. 9, 2014

(54) METHOD AND APPARATUS FOR ASSOCIATING USERS

(71) Applicant: Beijing Xiaomi Technology Co., Ltd., Beijing (CN)

(72) Inventor: Yang Shen, Beijing (CN)

(21) Appl. No.: 13/923,485

(22) Filed: Jun. 21, 2013

(30) Foreign Application Priority Data
Jul. 4, 2012 (CN) CN201210230673.7

(51) Int. Cl. H04L 29/08

(52) U.S. Cl. CPC H04L 67/306
USPC 709/204

(57) ABSTRACT

A method and apparatus for associating users. The method includes receiving association items from a plurality of users; determining, from the received associated items, a set of association items conforming to a predetermined rule using a processor, wherein the set of association items is determined based on account identifiers that are not locally registered account identifiers; and establishing an association relation based on the set of association items.

### RELATED APPLICATIONS

This application is based upon and claims the benefit of priority from Chinese Patent Application No. CN201210230673.7, filed Jul. 4, 2012, the entire contents of which are incorporated herein by reference.

### TECHNICAL FIELD

The present disclosure generally relates to the field of communications, and more particularly to method and apparatus of associating users.

### BACKGROUND

With the development of communications and internet technology, more and more applications of all functions and purposes have been developed, which include, for example, instant communication application, social applications, gourmet food applications, photography work applications, shopping applications, reading applications and sports applications.

When a user using these applications intends to find other users using the same, the user can search by the account name or account ID if the account name or account ID is known to the user.

### SUMMARY

Disclosed herein are implementations of systems, methods, and apparatuses for associating users. The present disclosure provides a method for associating users, which includes: receiving association items from a plurality of users; determining, from the received associated items, a set of association items conforming to a predetermined rule using a processor, wherein the set of association items is determined based on account identifiers that are not locally registered account identifiers; and establishing an association relation based on the set of association items.

In another aspect, the disclosure further provides an apparatus for associating users, which includes a memory and a processor configured to execute instructions stored in the memory to receive association items from a plurality of users; determine, from the received associated items, a set of association items conforming to a predetermined rule, wherein the set of association items is determined based on account identifiers that are not locally registered account identifiers; and establish an association relation based on the set of association items.

In another aspect, the disclosure includes a non-transitory computer-readable medium having stored thereon a program of instructions executable by one or more computing devices to cause the one or more computing devices to receive association items from a plurality of users; determine, from the received associated items, a set of association items conforming to a predetermined rule, wherein the set of association items is determined based on account identifiers that are not locally registered account identifiers; and establish an association relation based on the set of association items.

Features of the present disclosure will be set forth in the description of disclosure that follows, and will be apparent, in part, from the description or may be learned by practice of the disclosure.

The present disclosure is further described below in details through the drawings and implementations.

### BRIEF DESCRIPTION OF THE DRAWINGS

The drawings are used to provide further understanding about the present disclosure, constitute a part of the description, are used together with the implementations of the present disclosure to explain the present disclosure, and do not constitute any limitation to the present disclosure.

FIG. 1 is a flowchart of implementations of a method for associating users according to the present disclosure;

FIG. 2 is a flowchart of a first implementation of the method for associating users according to the present disclosure;

FIG. 3 is a flowchart of a second implementation of the method for associating users according to the present disclosure;

FIG. 4 is a flowchart of a third implementation of the method for associating users according to the present disclosure;

FIG. 5 is a flowchart of a fourth implementation of the method for associating users according to the present disclosure;

FIG. 6 is a schematic view of implementations of an apparatus for associating users according to the present disclosure;

FIG. 7 is a schematic view of a first implementation of the apparatus for associating users according to the present disclosure; and

FIG. 8 is a schematic view of a second implementation of the apparatus for associating users according to the present disclosure.

### DETAILED DESCRIPTION

When a user using an application intends to find other users using the same application, the user can search by an account identifier, such as account name or account number, if the account identifier is known to the user. The user can also find the other users by recommendations through friends according to friend relationship. In addition, the user can use location-based service, in which a positioning function of a terminal where the application software is installed can be used for finding friends. For example, other users within a certain area from the user's current geographical position can be located using positioning technology. However, positioning or distance calculation may be inaccurate. Also, the user may not want to find or add friends just based on the same geographic area. The association relation among users can be established by receiving the association items sent by the users and according to some predetermined rules, thereby providing a convenient and highly pertinent solution for associating users.

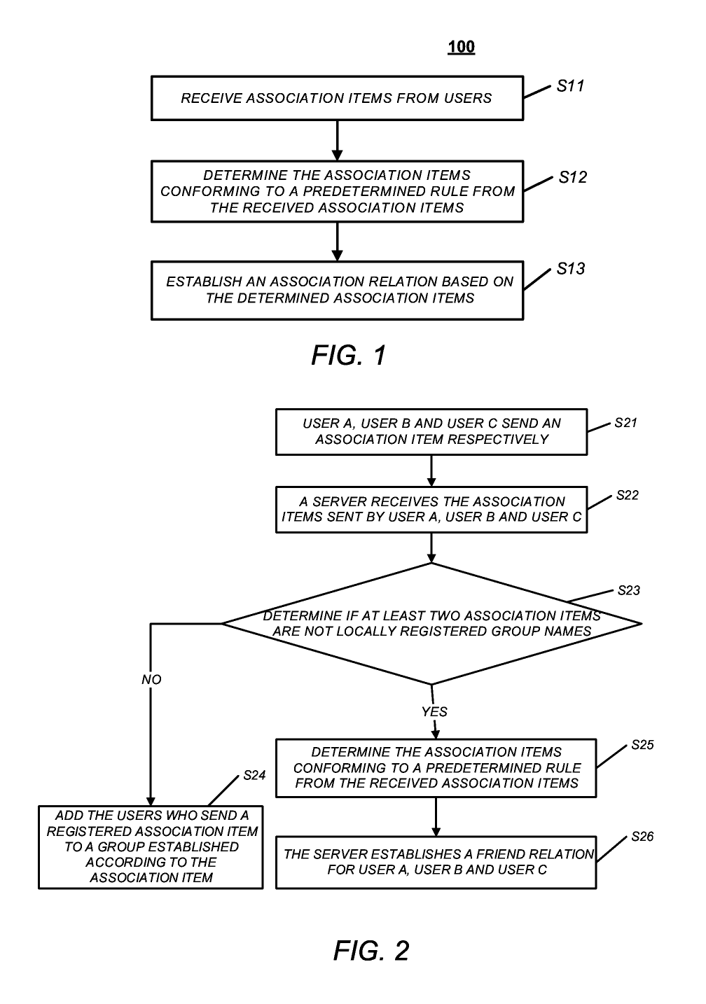

FIG. 1 illustrates implementations of a method 100 for associating users according to the present disclosure.

At a Step S11, multiple association items can be received from a plurality of users.

At a Step S12, a set of the association items conforming to a predetermined rule can be determined from the received association items, in which the determined association items can be account identifiers that are not locally registered account identifiers.

At a Step S13, an association relation can be established for the users corresponding to the determined association items.

In the present disclosure, in some implementations, the associating users can be carried out directly according to the association items sent by the users without requiring the users to register the association items on a server in advance, allowing convenient and efficient user search and association.

In the present disclosure, an association item can be a message in any form sent by the users, such as text, picture, audio, and video. The association item can be used to determine if a plurality of users can be associated. A predetermined rule can be used for determining the received association items, that is, a rule can be preset for associating users who send out an association item conforming to the rule. The predetermined rule can include, for example, identical association items, association items under the same category, and association items belonging to the same song, movie or team, and the like. In addition, in some implementations of the present disclosure, the determined association items can be account identifiers that are not locally registered account identifiers. For example, the determined association items can include individual account identifiers or group names that are not locally registered, or the like.

FIGS. 2-5 further illustrate implementations of method 100 for associating users according to the present disclosure. FIG. 2 illustrates a first implementation of associating users. At a Step S21, User A, User B and User C send an association item through a client respectively. In this implementation, the association item is a text and all the association items sent by User A, User B and User C are “Class 2 Grade 3.”

At a Step S22, a server receives the association items respectively sent by User A, User B and User C.

At a Step S23, the server determines if at least two association items of the received association items are not locally registered group names; and if so, a Step S25 is executed, and if not, a Step S24 is executed. In this implementation, all three association items sent by the users are not locally registered, hence Step S25 is executed.

At Step S24, the users who send a registered association item are added to a group established according to the association item.

At Step S25, the association items conforming to the predetermined rule are determined from the received association items. In this implementation, the predetermined rule is set to “identical association items”, so in this implementation, the association item conforming to the predetermined rule of “identical association items” is determined from the received association items as the “Class 2 Grade 3” sent by the three users.

At a Step S26, the server establishes a friend relation for User A, User B and User C corresponding to the association item “Class 2 Grade 3”. Here, a friend group can be directly established for User A, User B and User C.

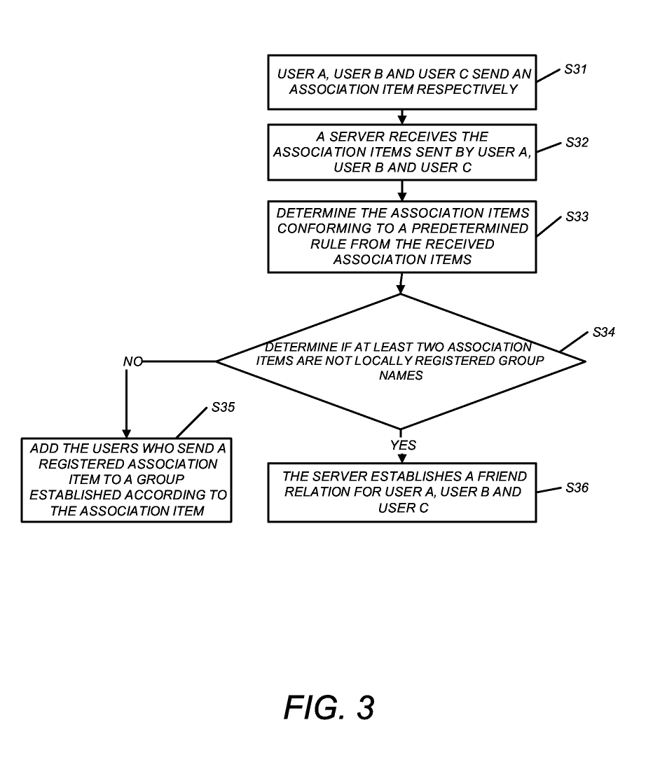

FIG. 3 illustrates a second implementation of associating users. At a Step S31, User A, User B and User C send an association item through a client respectively. In this implementation, the association item is a text and all the association items sent by User A, User B and User C are “Class 2 Grade 3.”

At a Step S32, a server receives the association items respectively sent by User A, User B and User C.

At a Step S33, the association items conforming to a predetermined rule are determined from the received association items. In this implementation, the predetermined rule is “identical association items”, so the “Class 2 Grade 3” is determined as the association item conforming to the predetermined rule.

At a Step S34, it is determined if at least two association items of the determined association items are account identifiers that are not locally registered account identifiers; and if so, a Step S36 is executed, and if not, a Step S35 is executed. In this implementation, all three association items sent by the users are not locally registered, hence Step S36 is executed.

At Step S35, the users who send a registered association item are added to a group established according to the association item.

At Step S36, a friend relation is established for User A, User B and User C corresponding to the determined association items “Class 2 Grade 3”. Here, a friend group can be directly established for User A, User B and User C.

In the above two implementations, a step of determining if the association items are locally registered account identifiers can be added, which can be executed after the association items are received or after the association items are determined.

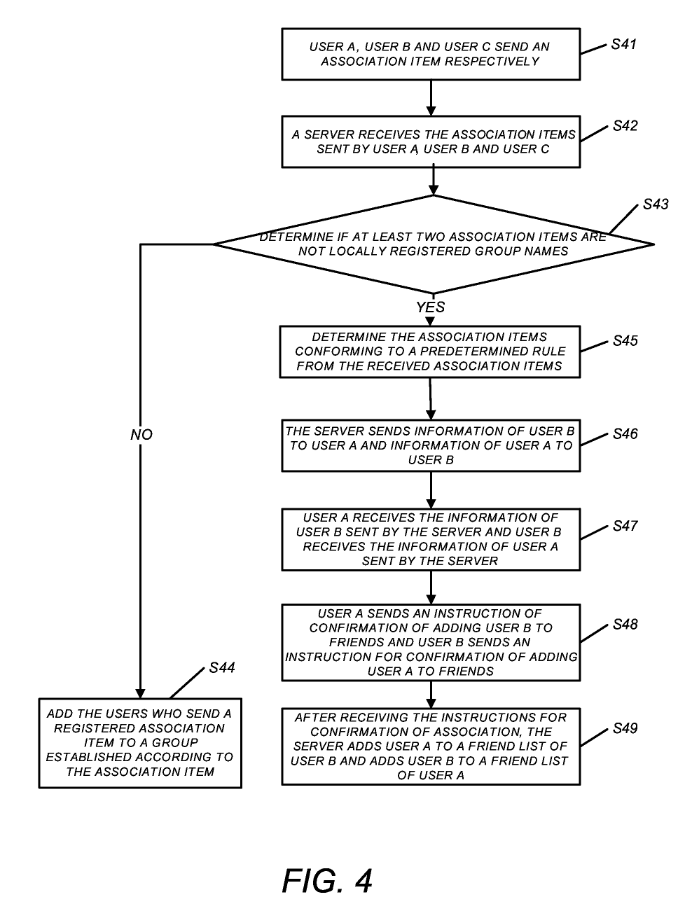

FIG. 4 illustrates a third implementation of associating users. At a Step S41, User A, User B and User C send an association item through a client respectively. In this implementation, the association items sent by User A and User B are “Class 2 Grade 3”, and the association item sent by User C is “Class 3 Grade 3.”

At a Step S42, a server receives the association items respectively sent by User A, User B and User C.

At a Step S43, it is determined if at least two association items of the received association items are not locally registered group names; and if so, a Step S45 is executed, and if not, a Step S44 is executed. In this implementation, all three association items sent by the users are not locally registered group names, hence Step S45 is executed.

At Step S44, the users who send a registered association item are added to a group established according to the association item.

At Step S45, the association items conforming to a predetermined rule are determined from the received association items. In this implementation, the predetermined rule is set to “identical association items”, so in this implementation, the association item conforming to the predetermined rule of “identical association items” is determined from the received association items as the “Class 2 Grade 3” sent by User A and User B.

At a Step S46, the server sends information of User B to User A and sends information of User A to User B.

At a Step S47, User A receives the information of User B sent by the server through the client and User B receives information of User A sent by the server through the client.

At a Step S48, User A sends an instruction for confirmation of adding User B to friends through the client and User B sends an instruction for confirmation of adding User A to friends through the client.

At a Step S49, the server, after receiving the instructions for confirmation of association, adds User A to a friend list of User B and adds User B to a friend list of User A.

In this implementation, information of the users to be associated is first sent to the clients and then the users to be associated are added to friends or contacts according to the users' confirmation, which provides the users with further confirmation, so that the association is more accurate.

Generally, a user can register a group name/group ID on the server in advance, and any user who wants to join in the group need to acquire the group name/group ID and then send the group name/group ID to the server. Then, the server adds the user who sends the group ID to the corresponding group. However, in the present disclosure, the association item is not required to be registered by a user in advance, and the association may be realized only by sending an association item conforming to a predetermined rule to the server by a plurality of users in need of association. Therefore, the present disclosure allows convenient and efficient user search and association.

In the above implementations, the association items are in form of text. It should be understood to those of ordinary skills in the art that the association items may be information in any form sent by a client, for example, pictures, audio and the like. The server is required to perform different analysis for different kinds of the received association items. In addition to “identical association items”, the predetermined rule may also be set as association items in a defined range, which provides a more flexible association.

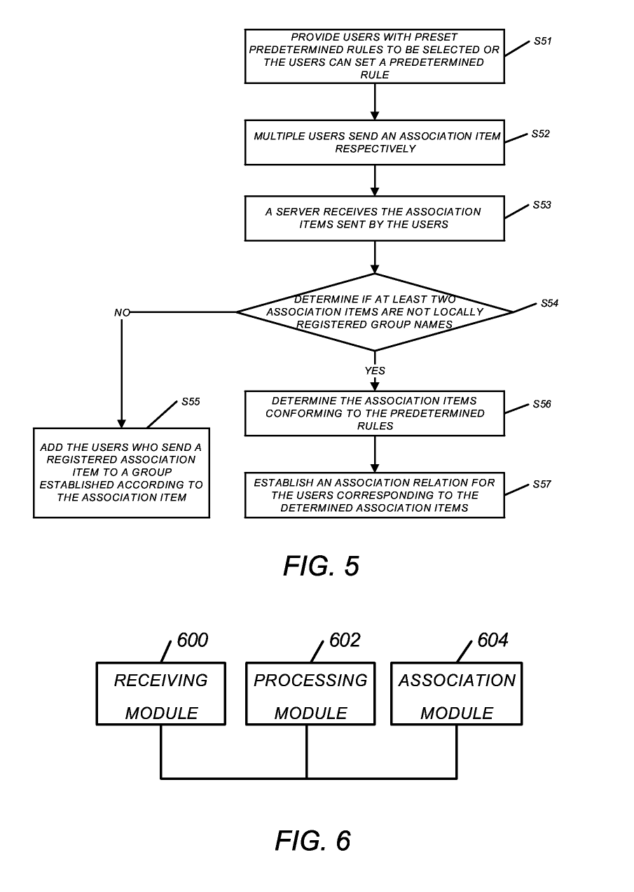

FIG. 5 illustrates a fourth implementation of associating users. At a Step S51, users are provided with a plurality of preset predetermined rules to be selected. For example, the users may select among the predetermined rules of “identical association items”, “association items under the same category”, “categories of the association items” etc. Or, the users may set a predetermined rule for association themselves. In this implementation, it is assumed that the user chooses “association items belonging to the same song” as the predetermined rule.

At a Step S52, a plurality of users send an association item through a client respectively. In this implementation, the association item sent by User A is a piece of lyrics of Song A, the association item sent by User B is a piece of melody of Song A, and the association item sent by User C is the name of Song A.

At a Step S53, a server receives the association items sent by the users.

At a Step S54, it is determined if at least two association items of the received association items are not locally registered group names; and if so, Step S56 is executed, and if not, Step S55 is executed. In this implementation, all three association items sent by the users are not locally registered, hence Step S56 is executed.

At Step S55, the users who send a registered association item are added to a group established according to the association item.

At Step S56, the association items conforming to the predetermined rule are determined from the received association items. In this implementation, the predetermined rule is set as “association items belonging to the same song”, so the determined association items conforming to the predetermined rule of “association items belonging to the same song” from the received association items are the association item of “a piece of lyrics of Song A” sent by User A, the association item of “a piece of melody of Song A” sent by User B, and the association item of “name of Song A” sent by User C.

At a Step S57, a friend relation is established for User A, User B and User C.

A fifth implementation can be based on the above implementations. In this implementation, after receiving the association items sent by the users, the method may further include providing the users with a plurality of matching options of the association items and determining final association items based on the users' selection.

For example, the association items sent by User A and User B are “Titanic”, and the association item sent by User C is “titanic”. After the association items sent by the users are received, a list is provided for the users to be confirmed. The list contains matching options relating to “Titanic” or “titanic”. For example, the list provided to User A and User B contains information such as “Titanic novel”, “Titanic movie”, “Titanic theme song”, “Titanic film director”, and “Titanic chief actor”, and the list provided to User B may contain information such as “Titanic, Titanic novel”, “Titanic movie”, “Titanic theme song”, “Titanic film director”, and “Titanic chief actor”. Then, final association items are confirmed based on the users' selection. For example, when User A selects the “Titanic theme song”, User B selects the “Titanic novel”, and User C selects the “Titanic theme song”, the association items sent by User A, User B and User C are finally “Titanic theme song”, “Titanic novel”, “Titanic theme song”. If, for example, the predetermined rule in this implementation is set as the “identical association items”, a friend relation can be established between User A and User C.

The above implementation provides an opportunity for the users to make further confirmation and selection, which allows more precise user search and association.

A sixth implementation can be based on the above implementations. In this implementation, after receiving the association items sent by a plurality of users, the method may further include performing a semantic analysis on the received association items and determining synonymous or near-synonymous association items as the same association items.

For example, after receiving the association items which respectively are “tomorrow the proposal is going to be passed”, “the proposal is going to be passed tomorrow”, and “tomorrow it is going to pass the proposal” sent by a plurality of users and performing a semantic analysis, a conclusion that the three association items have the same meaning is obtained and then the three association items are determined to be the same association items. This implementation may provide a more intelligent association.

A seventh implementation can based on the above implementations. In this implementation, the predetermined rules can be set with respect to the association items themselves. To further improve the relevancy and precision for associating users, limitations like the time and location of the association items may be added in the predetermined rules. For example, the predetermined rules can include rules that specify that the association items are received in a predetermined time and/or sending locations of the association items are in a predetermined area.

This rule setting can be added with the time and/or location limitations based on the association items, thereby avoiding the confusion when two groups of users adopt the same association items. So, this rule setting is more accurate and particularly suitable for association of users who are joined together temporarily.

For example, a group of friends are about to go mountain climbing. The predetermined rule for associating users may be set as follows: the association item is the text “mountain climbing” and the conditions are satisfied that the association items are received between 9:00 to 9:05 or the association items are sent out within an area of 10 m, or both. The association will not be carried out unless all these conditions are satisfied. In this manner, the setting of the predetermined rule is tailored and highly pertinent. Preferably, the location may be automatically positioned and sent out by the equipment or may be input manually by the users. For example, if this method is applied on a desktop computer, the location may be input manually to serve as the condition of area.

Accordingly, the present disclosure provides an apparatus for associating users, as shown in FIG. 6, according to implementations of the present disclosure. The apparatus can be, for example, a terminal such as a mobile phone. The apparatus can include, for example, a memory and a processor (such as CPU). The memory can store data and instructions to be executed by the processor. In some implementations, the instructions can be implemented as modules (such as software modules), and the apparatus can include a receiving module 600 configured to receive association items sent by a plurality of users; a processing module 602 configured to determine the association items conforming to a predetermined rule from the received association items, in which the determined association items are account identifiers that are not locally registered account identifiers; and an association module 604 configured to establish an association relation for the users corresponding to the determined association items.

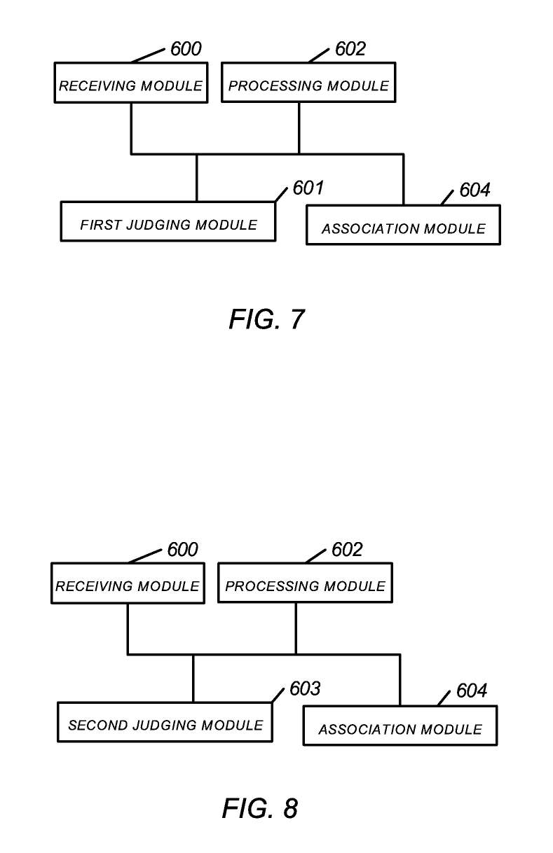

As shown in FIGS. 7 and 8, the apparatus may further include a first judging module 601 configured to determine if at least two association items of the received association items are account identifiers that are not locally registered account identifiers before determining the association items conforming to a predetermined rule from the received association items, and if so, determine the association items conforming to the predetermined rule from the association items that are not locally registered account identifiers; or a second judging module 603 configured to determine if at least two association items of the determined association items are not locally registered account identifiers before establishing an association relation for the users corresponding to the determined association items, and if so, establish an association relation for the users corresponding to the association items that are not locally registered account identifiers.

In the above implementations, the association module 604 can be configured to send information of other users corresponding to the determined association items to each of the users corresponding to the determined association items and establish an association relation between the user and one or more of other users according to an instruction of association confirmation sent by the user.

For example, the predetermined rule can include the limitations that the association items are received in a predetermined time and/or sending locations of the association items are in a predetermined area.

The apparatus for associating users may further include a matching module configured to provide the users with a plurality of matching options of the association items after receiving the association items sent by the users and determine final association items based on the users' selection.

The apparatus for associating users may further include an analyzing module configured to perform a semantic analysis on the association items after receiving the association items sent by a plurality of users and determine synonymous or near-synonymous association items as the same association item.

The association relation can include a one-to-one association relation and/or a shared association relation.

It should be understood to those of ordinary skills in the art that the implementations of the present disclosure may be presented as methods, systems or computer program products. Accordingly, the present disclosure may take the form of an entirely hardware implementation, an entirely software implementation, or an implementation combining hardware and software. Moreover, the present disclosure can take the form of a computer program product which may be implemented on one or more computer usable storage media (including, but not limited to, disk storage and optical storage, etc.) in which computer usable program code is contained.

The present disclosure has been described with reference to the flowcharts and/or block diagrams of the method, apparatus (system) and computer program product according to the implementations of the present disclosure. It should be understood that each flow and/or block in the flowcharts and/or block diagrams, and a combination of a flow and/or block in the flowcharts and/or block diagrams may be realized by computer program instructions. These computer program instructions may be provided into a general purpose computer, special purpose computer, embedded processor, or processor of other programmable data processing apparatus to produce a machine, so that the apparatus for implementing the functions specified in one or more flows of the flowcharts or in one or more blocks of the block diagrams is generated through the instructions executed by the computer or the processor of other programmable data processing apparatus.

These computer program instructions may also be stored in a computer-readable memory that can direct a computer or other programmable data processing apparatus to work in a specific manner, so that instructions stored in the computer-readable memory generate an article of manufacture including an instruction apparatus. The instruction apparatus implements the functions specified in one or more flows of the flowcharts and/or in one or more blocks of the block diagrams.

These computer program instructions may also be loaded onto a computer or other programmable data processing apparatus, so that a series of operations may be executed on the computer or other programmable apparatus to produce a computer-implemented processing, and thus the instructions executed on the computer or other programmable apparatus provide the steps of realizing the functions specified in the one or more flows of the flowcharts and/or in one or more blocks of the block diagrams.

Reference made to the accompanying drawings in which the same numbers in different drawings represent the same or similar elements unless otherwise represented. The implementations set forth in the description of exemplary embodiments do not represent all implementations consistent with the invention. Instead, they are merely examples of apparatuses and methods consistent with aspects related to the invention as recited in the appended claims.

It will be apparent to those skilled in the art that various modifications and variations can be made in the present disclosure without departing from the scope or spirit of the disclosure. As such, all such modifications and variations are intended to be included within the scope of the present disclosure, provided that they fall within the scope of the claims of the present disclosure and equivalents thereof.

What is claimed is:

1. A method for associating users, comprising:
receiving association items from a plurality of users;
determining, from the received associated items, a set of association items conforming to a predetermined rule using a processor, wherein the set of association items is determined based on account identifiers that are not locally registered account identifiers; and
establishing an association relation based on the set of association items.

2. The method of claim 1, wherein determining, from the received associated items, the set of association items conforming to the predetermined rule comprises:
determining if at least two association items from the received association items are not locally registered account identifiers; and
if it is determined that at least two association items form the received association items are not locally registered account identifiers, determining the set of association items conforming to the predetermined rule based on the at least two association items.

3. The method of claim 1, wherein establishing the association relation based on the set of association items comprises:
determining if at least two association items of the set of association items are not locally registered account identifiers; and
if it is determined that at least two association items of the set of association items are not locally registered account identifiers, establishing the association relation for the users corresponding to the at least two association items.

4. The method of claim 1, wherein establishing the association relation based on the set of association items comprises:
sending, to at least one user corresponding to the set of associated items, information of at least one other user corresponding to the set of associated items; and
establishing an association relation between the at least one user and the at least one other user according to an instruction to confirm association sent by the at least one user.

5. The method of claim 1, further comprising:
providing a plurality of matching options of the received association items and determining the set of association items based on a selection by a user from the plurality of matching options.

6. The method of claim 1, further comprising:
performing a semantic analysis on the received association items; and
determining synonymous or near-synonymous association items as the same association items.

7. The method of claim 1, wherein the association relation comprises a one-to-one association relation, or a shared association relation, or both.

8. The method of claim 1, wherein the predetermined rule includes at least one of: the association items are received within a predetermined time, or sending locations of the association items are within a predetermined area.

9. An apparatus for associating users, comprising:
a memory; and
a processor configured to execute instructions stored in the memory to:
receive association items from a plurality of users;
determine, from the received associated items, a set of association items conforming to a predetermined rule, wherein the set of association items is determined based on account identifiers that are not locally registered account identifiers; and
establish an association relation based on the set of association items.

10. The apparatus of claim 9, wherein the processor is configured to determine, from the received associated items, the set of association items conforming to a predetermined rule by:
determining if at least two association items from the received association items are not locally registered account identifiers; and
if it is determined that at least two association items form the received association items are not locally registered account identifiers, determining the set of association items conforming to the predetermined rule based on the at least two association items.

11. The apparatus of claim 9, wherein the processor is configured to establish the association relation based on the set of association items by:
determining if at least two association items of the set of association items are not locally registered account identifiers; and
if it is determined that at least two association items of the set of association items are not locally registered account identifiers, establishing the association relation for the users corresponding to the at least two association items.

12. The apparatus of claim 9, wherein the processor is configured to establish the association relation based on the set of association items by:
sending, to at least one user corresponding to the set of associated items, information of at least one other user corresponding to the set of associated items; and
establishing an association relation between the at least one user and the at least one other user according to an instruction to confirm association sent by the at least one user.

13. The apparatus of claim 9, wherein the processor is further configured to:
provide a plurality of matching options of the received association items and determine the set of association items based on a selection by a user from the plurality of matching options.

14. The apparatus of claim 9, wherein the processor is further configured to:
perform a semantic analysis on the received association items and determine synonymous or near-synonymous association items as the same association items.

15. The apparatus of claim 9, wherein the association relation comprises a one-to-one association relation, or a shared association relation, or both.

16. The apparatus of claim 9, wherein the predetermined rule includes at least one of:
the association items are received within a predetermined time, or sending locations of the association items are within a predetermined area.

17. A non-transitory computer-readable medium having stored thereon a program of instructions executable by one or more computing devices to cause the one or more computing devices to:
receive association items from a plurality of users;
determine, from the received associated items, a set of association items conforming to a predetermined rule, wherein the set of association items is determined based on account identifiers that are not locally registered account identifiers; and
establish an association relation based on the set of association items.

18. The non-transitory computer-readable medium of claim 17, wherein the instructions to establish the association relation based on the set of association items include instructions to:
send, to at least one user corresponding to the set of associated items, information of at least one other user corresponding to the set of associated items; and
establish an association relation between the at least one user and the at least one other user according to an instruction to confirm association sent by the at least one user.

19. The non-transitory computer-readable medium of claim 17, further comprising instructions executable by one or more computing devices to cause the one or more computing devices to:
provide the users with a plurality of matching options of the received association items and determine the set of association items based on the users' selection.
